(19) United States
(12) Patent Application Publication
(10) Pub. No.: US 2026/0073680 A1
(43) Pub. Date: Mar. 12, 2026

(54) SELECTING IMAGE SENSOR FOR OBJECT CLASSIFICATION

(71) Applicant: Snap Inc., Santa Monica, CA (US)

(72) Inventors: Attila Alvarez, Vienna (AT); Thomas Faeulhammer, Vienna (AT); Gabor Nemeth, Gyor (HU); David Retek, Budapest (HU)

(21) Appl. No.: 18/827,175

(22) Filed: Sep. 6, 2024

(51) Int. Cl. G06V 10/98; G06V 10/10; G06V 10/26; G06V 10/764; G06V 10/82; G06V 40/20

(52) U.S. Cl. CPC G06V 10/993; G06V 10/10; G06V 10/26; G06V 10/764; G06V 10/82; G06V 40/28

(57) ABSTRACT

A head-worn device system includes multiple image sensors (e.g., cameras), one or more display devices and one or more processors. The system also includes a memory storing instructions that, when executed by the one or more processors, configure the system to obtain a first image captured by a first image sensor of the device; generate, based on obtaining the first image, a respective predicted skeleton corresponding to a respective view from each of the first image sensor and the one or more second image sensors; select, based on generating the respective predicted skeletons, an image sensor from among the first image sensor and the one or more second image sensors, the selected image sensor being used for classifying the first image; and determine, based on the selected image sensor, a classification for the first image.

### TECHNICAL FIELD

The present disclosure relates generally to display devices and more particularly to display devices used for augmented and virtual reality.

### BACKGROUND

A head-worn device may be implemented with a transparent or semi-transparent display through which a user of the head-worn device can view the surrounding environment. Such devices enable a user to see through the transparent or semi-transparent display to view the surrounding environment, and to also see objects (e.g., virtual objects such as 3D renderings, images, video, text, and so forth) that are generated for display to appear as a part of, and/or overlaid upon, the surrounding environment. This is typically referred to as “augmented reality” or “AR.” A head-worn device may additionally completely occlude a user's visual field and display a virtual environment through which a user may move or be moved. This is typically referred to as “virtual reality” or “VR.” Collectively, AR and VR as known as “XR” where “X” is understood to stand for either “augmented” or “virtual.” As used herein, the term XR refers to either or both augmented reality and virtual reality as traditionally understood, unless the context indicates otherwise.

A user of the head-worn device may access and use a computer software application to perform various tasks or engage in an entertaining activity. To use the computer software application, the user interacts with a 3D user interface provided by the head-worn device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a perspective view of a head-worn device, in accordance with some examples.

FIG. 2 illustrates a further view of the head-worn device of FIG. 1, in accordance with some examples.

FIG. 3 is a block diagram illustrating a networked system 300 including details of the head-worn device of FIG. 1, in accordance with some examples.

FIG. 4 is a diagrammatic representation of a networked environment in which the present disclosure may be deployed, in accordance with some examples.

FIG. 5 depicts a sequence diagram of an example user interface process in accordance with some examples.

FIG. 6 illustrates a pipeline for gesture recognition without camera selection, in accordance with some examples.

FIG. 7 illustrates a pipeline for gesture recognition with camera selection, in accordance with some examples.

FIGS. 8A-8B illustrate examples of selecting a camera based on skeleton-based rules, in accordance with some examples.

FIGS. 9A-9B illustrate examples of selecting a camera using a neural-network based prediction, in accordance with some examples.

FIG. 10 is a flowchart illustrating a process for selecting an image sensor for object classification, in this case gesture recognition, in accordance with some examples.

FIG. 11 is a block diagram showing a software architecture within which the present disclosure may be implemented, in accordance with some examples.

FIG. 12 is a diagrammatic representation of a machine, in the form of a computer system within which a set of instructions may be executed for causing the machine to perform any one or more of the methodologies discussed herein in accordance with some examples.

### DETAILED DESCRIPTION

Some head-worn XR devices, such as AR glasses, include a transparent or semi-transparent display that enables a user to see through the transparent or semi-transparent display to view the surrounding environment. Additional information or objects (e.g., virtual objects such as 3D renderings, images, video, text, and so forth) are shown on the display and appear as a part of, and/or overlaid upon, the surrounding environment to provide an augmented reality (AR) experience for the user. The display may for example include a waveguide that receives a light beam from a projector but any appropriate display for presenting augmented or virtual content to the wearer may be used.

As referred to herein, the phrase “augmented reality experience,” includes or refers to various image processing operations corresponding to an image modification, filter, media overlay, transformation, and the like, as described further herein. In example embodiments, these image processing operations provide an interactive experience of a real-world environment, where objects, surfaces, backgrounds, lighting and so forth in the real world are enhanced by computer-generated perceptual information. In this context an “augmented reality effect” comprises the collection of data, parameters, and other assets used to apply a selected augmented reality experience to an image or a video feed. In example embodiments, augmented reality effects are provided by Snap, Inc. under the registered trademark LENSES.

In example embodiments, a user's interaction with software applications executing on an XR device is achieved using a 3D User Interface. The 3D user interface includes virtual objects displayed to a user by the XR device in a 3D render displayed to the user. In the case of AR, the user perceives the virtual objects as objects within an overlay in the user's field of view of the real world while wearing the XR device. In the case of VR, the user perceives the virtual objects as objects within the virtual world as viewed by the user while wearing the XR device To allow the user to interact with the virtual objects, the XR device detects the user's hand positions and movements and uses those hand positions and movements to determine the user's intentions in manipulating the virtual objects.

Generation of the 3D user interface and detection of the user's interactions with the virtual objects may also include detection of real world objects (e.g., faces, hands, bodies, cats, dogs, surfaces, objects), tracking of such real world objects as they leave, enter, and move around the field of view in video frames, and the modification or transformation of such real world objects as they are tracked. In various examples, different methods for detecting the real world objects and achieving such transformations may be used. For example, some examples may involve generating a 3D mesh model of a real world object or real world objects, and using transformations and animated textures of the model within the video frames to achieve the transformation. In other examples, tracking of points on a real world object may be used to place an image or texture, which may be two dimensional or three dimensional, at the tracked position. In still further examples, neural network analysis of video frames may be used to place images, models, or textures in content (e.g., images or frames of video). XR effect data thus may include both the images, models, and textures used to create transformations in content, as well as additional modeling and analysis information used to achieve such transformations with real world object detection, tracking, and placement.

XR devices are usually equipped with multiple image sensors (e.g., cameras). To perform gesture recognition, it is possible to run gesture recognition processing on all cameras. While this approach may result in high accuracy, such processing with respect to all cameras is resource-intensive. The disclosed embodiments provide for certain tasks, such as gesture recognition, to be performed using a single camera while maintaining high accuracy. Due to occlusion (e.g., including self-occlusion) of the hand, certain cameras may have a better angle to detect certain gestures (e.g., a pinch gesture). Thus, the disclosed embodiments aim to select the preferred camera from which a given gesture is most visible.

The disclosed embodiments provide for an XR device to obtain an image captured by a first camera of the multiple device cameras. The XR device generates a respective predicted skeleton for each of the device cameras. Based on the predicted skeletons, the XR device selects a camera, from among all the cameras, for classifying the image (e.g., for recognizing a hand gesture). The XR device may select the camera in different manners. In a first example, the camera is selected using skeleton-based rules, such as selecting a camera with a most visible pinch plane (e.g., for a pinch gesture) from the respective camera viewpoint. In a second example, the camera is selected using a neural-network based prediction, such as selecting an image/predicted skeleton with the least amount of occlusion. After selecting the camera, the XR device determines a classification for the first image (e.g., determines the hand gesture) using the selected camera.

Other technical features may be readily apparent to one skilled in the art from the following figures, descriptions, and claims.

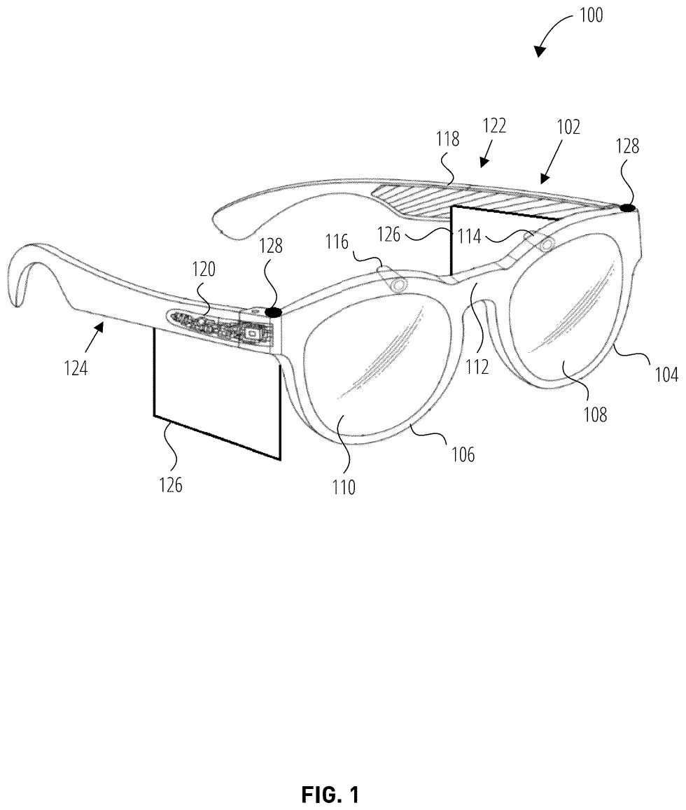

FIG. 1 is perspective view of a head-worn XR device (e.g., glasses 100), in accordance with some examples. The glasses 100 can include a frame 102 made from any suitable material such as plastic or metal, including any suitable shape memory alloy. In one or more examples, the frame 102 includes a first or left optical element holder 104 (e.g., a display or lens holder) and a second or right optical element holder 106 connected by a bridge 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing. Any suitable display assembly can be provided in the glasses 100.

The frame 102 additionally includes a left arm or temple piece 122 and a right arm or temple piece 124. In some examples the frame 102 can be formed from a single piece of material so as to have a unitary or integral construction.

The glasses 100 can include a computing device, such as a computer 120, which can be of any suitable type so as to be carried by the frame 102 and, in one or more examples, of a suitable size and shape, so as to be partially disposed in one of the temple piece 122 or the temple piece 124. The computer 120 can include one or more processors with memory, wireless communication circuitry, and a power source. As discussed below, the computer 120 comprises low-power circuitry, high-speed circuitry, and a display processor. Various other examples may include these elements in different configurations or integrated together in different ways. Additional details of aspects of computer 120 may be implemented as illustrated by the data processor 302 discussed below.

The computer 120 additionally includes a battery 118 or other suitable portable power supply. In example embodiments, the battery 118 is disposed in left temple piece 122 and is electrically coupled to the computer 120 disposed in the right temple piece 124. The glasses 100 can include a connector or port (not shown) suitable for charging the battery 118, a wireless receiver, transmitter or transceiver (not shown), or a combination of such devices.

The glasses 100 include a first or left camera 114 and a second or right camera 116. Although two cameras are depicted, other examples contemplate the use of a single or additional (i.e., more than two, such as four) cameras. In one or more examples, the glasses 100 include any number of input sensors or other input/output devices in addition to the left camera 114 and the right camera 116. Such sensors or input/output devices can additionally include biometric sensors, location sensors, motion sensors, and so forth.

In example embodiments, the left camera 114 and the right camera 116 provide video frame data for use by the glasses 100 to extract 3D information from a real world scene.

The glasses 100 may also include a touchpad 126 mounted to or integrated with one or both of the left temple piece 122 and right temple piece 124. The touchpad 126 is generally vertically-arranged, approximately parallel to a user's temple in some examples. As used herein, generally vertically aligned means that the touchpad is more vertical than horizontal, although potentially more vertical than that. Additional user input may be provided by one or more buttons 128, which in the illustrated examples are provided on the outer upper edges of the left optical element holder 104 and right optical element holder 106. The one or more touchpads 126 and buttons 128 provide a means whereby the glasses 100 can receive input from a user of the glasses 100.

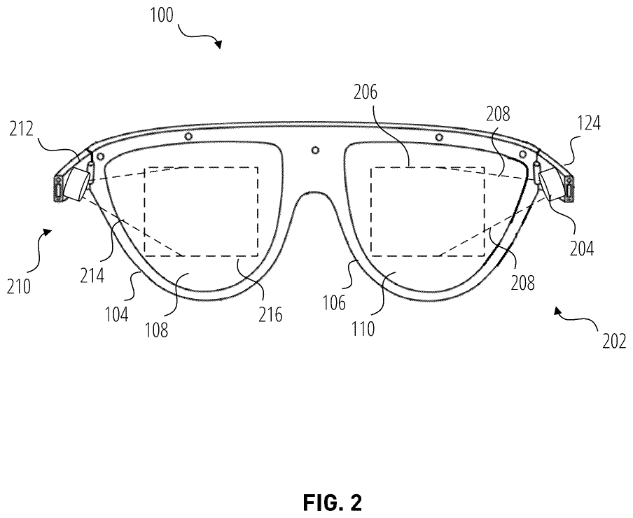

FIG. 2 illustrates the glasses 100 from the perspective of a user. For clarity, a number of the elements shown in FIG. 1 have been omitted. As described in FIG. 1, the glasses 100 shown in FIG. 2 include left optical element 108 and right optical element 110 secured within the left optical element holder 104 and the right optical element holder 106 respectively.

The glasses 100 include forward optical assembly 202 comprising a right projector 204 and a right near eye display 206, and a forward optical assembly 210 including a left projector 212 and a left near eye display 216.

In example embodiments, the near eye displays are waveguides. The waveguides include reflective or diffractive structures (e.g., gratings and/or optical elements such as mirrors, lenses, or prisms). Light 208 emitted by the projector 204 encounters the diffractive structures of the waveguide of the near eye display 206, which directs the light towards the right eye of a user to provide an image on or in the right optical element 110 that overlays the view of the real world seen by the user. Similarly, light 214 emitted by the projector 212 encounters the diffractive structures of the waveguide of the near eye display 216, which directs the light towards the left eye of a user to provide an image on or in the left optical element 108 that overlays the view of the real world seen by the user. The combination of a GPU, the forward optical assembly 202, the left optical element 108, and the right optical element 110 provide an optical engine of the glasses 100. The glasses 100 use the optical engine to generate an overlay of the real world view of the user including display of a 3D user interface to the user of the glasses 100.

It will be appreciated however that other display technologies or configurations may be utilized within an optical engine to display an image to a user in the user's field of view. For example, instead of a projector 204 and a waveguide, an LCD, LED or other display panel or surface may be provided.

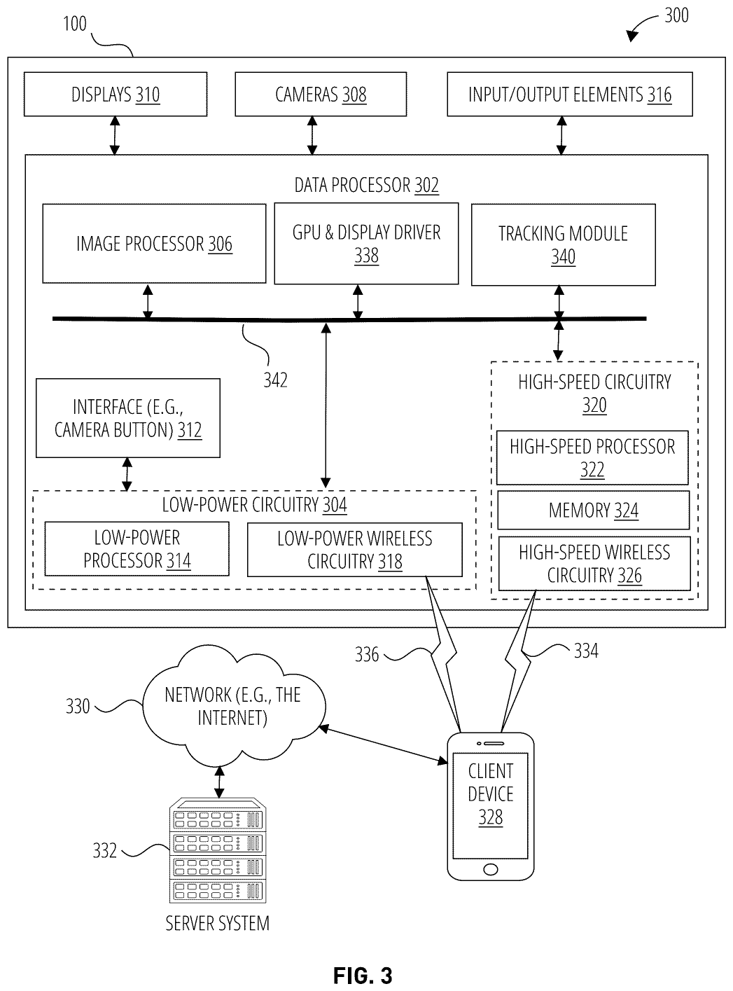

In use, a user of the glasses 100 will be presented with information, content and various 3D user interfaces on the near eye displays. As described in more detail herein, the user can then interact with the glasses 100 using a touchpad 126 and/or the buttons 128, voice inputs or touch inputs on an associated device (e.g. client device 328 illustrated in FIG. 3), and/or hand movements, locations, and positions detected by the glasses 100.

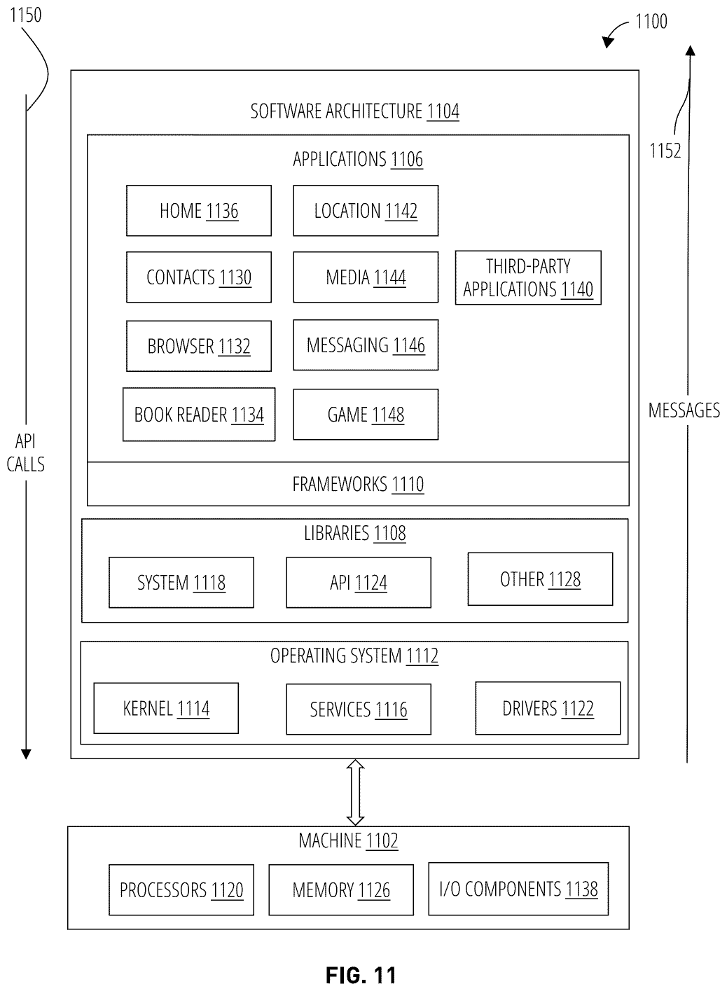

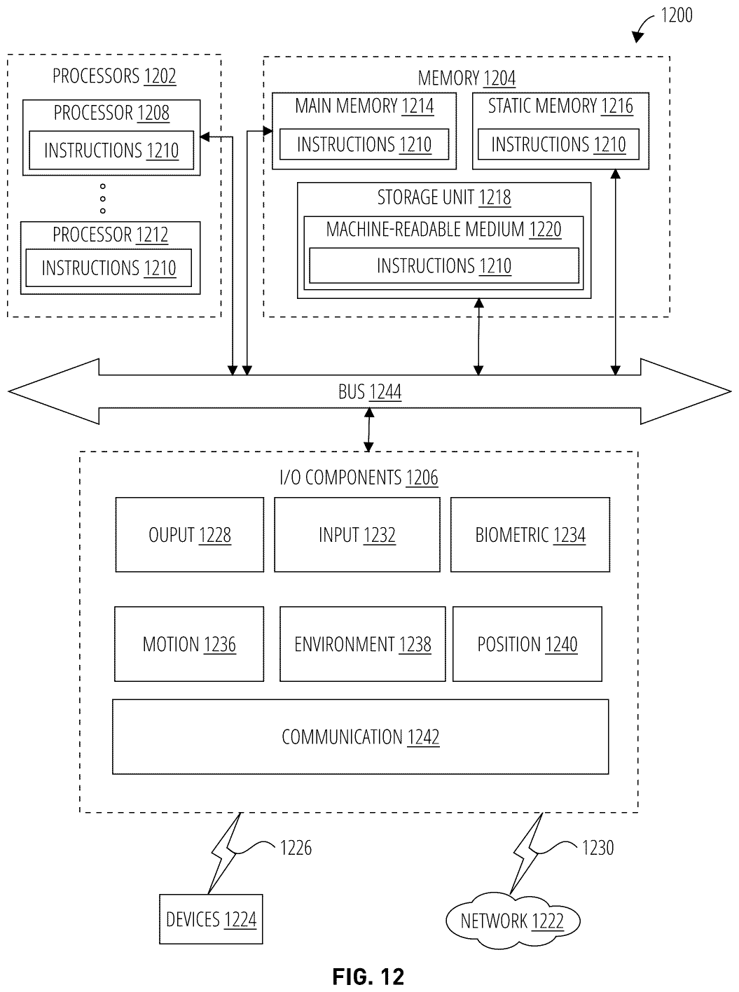

FIG. 3 is a block diagram illustrating a networked system 300 including details of the glasses 100, in accordance with some examples. The networked system 300 includes the glasses 100, a client device 328, and a server system 332. The client device 328 may be a smartphone, tablet, phablet, laptop computer, access point, or any other such device capable of connecting with the glasses 100 using a low-power wireless connection 336 and/or a high-speed wireless connection 334. The client device 328 is connected to the server system 332 via the network 330. The network 330 may include any combination of wired and wireless connections. The server system 332 may be one or more computing devices as part of a service or network computing system. The client device 328 and any elements of the server system 332 and network 330 may be implemented using details of the software architecture 1104 or the machine 1200 described in FIG. 11 and FIG. 12 respectively.

The glasses 100 include a data processor 302, displays 310, one or more cameras 308, and additional input/output elements 316. The input/output elements 316 may include microphones, audio speakers, biometric sensors, additional sensors, or additional display elements integrated with the data processor 302. Examples of the input/output elements 316 are discussed further with respect to FIG. 11 and FIG. 12. For example, the input/output elements 316 may include any of I/O components 1206 including output components 1228, motion components 1236, and so forth. Examples of the displays 310 are discussed in FIG. 2.

In the particular examples described herein, the displays 310 include a display for the user's left and right eyes.

The data processor 302 includes an image processor 306 (e.g., a video processor), a GPU & display driver 338, a tracking module 340, an interface 312, low-power circuitry 304, and high-speed circuitry 320. The components of the data processor 302 are interconnected by a bus 342.

The interface 312 refers to any source of a user command that is provided to the data processor 302. In one or more examples, the interface 312 is a physical button that, when depressed, sends a user input signal from the interface 312 to a low-power processor 314. A depression of such button followed by an immediate release may be processed by the low-power processor 314 as a request to capture a single image, or vice versa. A depression of such a button for a first period of time may be processed by the low-power processor 314 as a request to capture video data while the button is depressed, and to cease video capture when the button is released, with the video captured while the button was depressed stored as a single video file. Alternatively, depression of a button for an extended period of time may capture a still image. In example embodiments, the interface 312 may be any mechanical switch or physical interface capable of accepting user inputs associated with a request for data from the cameras 308. In other examples, the interface 312 may have a software component, or may be associated with a command received wirelessly from another source, such as from the client device 328.

The image processor 306 includes circuitry to receive signals from the cameras 308 and process those signals from the cameras 308 into a format suitable for storage in the memory 324 or for transmission to the client device 328. In one or more examples, the image processor 306 (e.g., video processor) comprises a microprocessor integrated circuit (IC) customized for processing sensor data from the cameras 308, along with volatile memory used by the microprocessor in operation.

The low-power circuitry 304 includes the low-power processor 314 and the low-power wireless circuitry 318. These elements of the low-power circuitry 304 may be implemented as separate elements or may be implemented on a single IC as part of a system on a single chip. The low-power processor 314 includes logic for managing the other elements of the glasses 100. As described above, for example, the low-power processor 314 may accept user input signals from the interface 312. The low-power processor 314 may also be configured to receive input signals or instruction communications from the client device 328 via the low-power wireless connection 336. The low-power wireless circuitry 318 includes circuit elements for implementing a low-power wireless communication system. Bluetooth™ Smart, also known as Bluetooth™ low energy, is one standard implementation of a low power wireless communication system that may be used to implement the low-power wireless circuitry 318. In other examples, other low power communication systems may be used.

The high-speed circuitry 320 includes a high-speed processor 322, a memory 324, and a high-speed wireless circuitry 326. The high-speed processor 322 may be any processor capable of managing high-speed communications and operation of any general computing system used for the data processor 302. The high-speed processor 322 includes processing resources used for managing high-speed data transfers on the high-speed wireless connection 334 using the high-speed wireless circuitry 326. In example embodiments, the high-speed processor 322 executes an operating system such as a LINUX operating system or other such operating system such as the operating system 1112 of FIG. 11. In addition to any other responsibilities, the high-speed processor 322 executing a software architecture for the data processor 302 is used to manage data transfers with the high-speed wireless circuitry 326. In example embodiments, the high-speed wireless circuitry 326 is configured to implement Institute of Electrical and Electronic Engineers (IEEE) 802.11 communication standards, also referred to herein as Wi-Fi. In other examples, other high-speed communications standards may be implemented by the high-speed wireless circuitry 326.

The memory 324 includes any storage device capable of storing camera data generated by the cameras 308 and the image processor 306. While the memory 324 is shown as integrated with the high-speed circuitry 320, in other examples, the memory 324 may be an independent standalone element of the data processor 302. In some such examples, electrical routing lines may provide a connection through a chip that includes the high-speed processor 322 from image processor 306 or the low-power processor 314 to the memory 324. In other examples, the high-speed processor 322 may manage addressing of the memory 324 such that the low-power processor 314 will boot the high-speed processor 322 any time that a read or write operation involving the memory 324 is desired.

The tracking module 340 estimates a pose of the glasses 100. For example, the tracking module 340 uses image data and corresponding inertial data from the cameras 308 and the position components 1240, as well as GPS data, to track a location and determine a pose of the glasses 100 relative to a frame of reference (e.g., real-world environment). The tracking module 340 continually gathers and uses updated sensor data describing movements of the glasses 100 to determine updated three-dimensional poses of the glasses 100 that indicate changes in the relative position and orientation relative to physical objects in the real-world environment. The tracking module 340 permits visual placement of virtual objects relative to physical objects by the glasses 100 within the field of view of the user via the displays 310.

The GPU & display driver 338 may use the pose of the glasses 100 to generate frames of virtual content or other content to be presented on the displays 310 when the glasses 100 are functioning in a traditional augmented reality mode. In this mode, the GPU & display driver 338 generates updated frames of virtual content based on updated three-dimensional poses of the glasses 100, which reflect changes in the position and orientation of the user in relation to physical objects in the user's real-world environment.

One or more functions or operations described herein may also be performed in an Application resident on the glasses 100 or on the client device 328, or on a remote server. For example, one or more functions or operations described herein may be performed by one of the Applications 1106 such as messaging Application 1146.

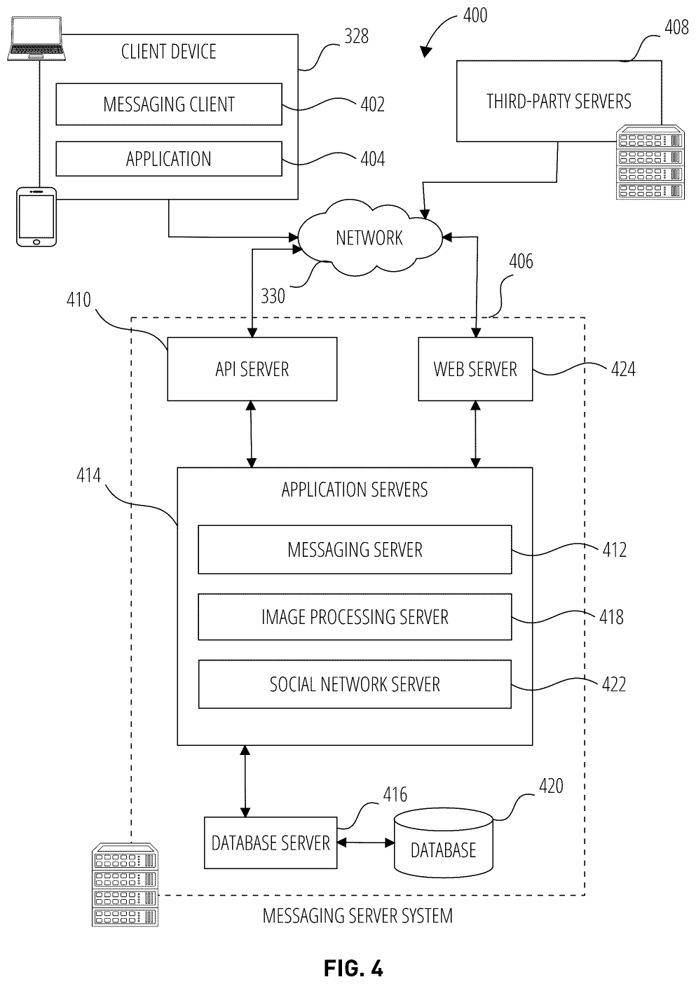

FIG. 4 is a block diagram showing an example messaging system 400 for exchanging data (e.g., messages and associated content) over a network. The messaging system 400 includes multiple instances of a client device 328 which host a number of Applications, including a messaging client 402 and other Applications 404. A messaging client 402 is communicatively coupled to other instances of the messaging client 402 (e.g., hosted on respective other client devices 328), a messaging server system 406 and third-party servers 408 via a network 330 (e.g., the Internet). A messaging client 402 can also communicate with locally-hosted Applications 404 using Applications Program Interfaces (APIs).

A messaging client 402 is able to communicate and exchange data with other messaging clients 402 and with the messaging server system 406 via the network 330. The data exchanged between messaging clients 402, and between a messaging client 402 and the messaging server system 406, includes functions (e.g., commands to invoke functions) as well as payload data (e.g., text, audio, video or other multimedia data). In example embodiments, the messaging server system 406 corresponds to the server system 332 of FIG. 3.

The messaging server system 406 provides server-side functionality via the network 330 to a particular messaging client 402. While some functions of the messaging system 400 are described herein as being performed by either a messaging client 402 or by the messaging server system 406, the location of some functionality either within the messaging client 402 or the messaging server system 406 may be a design choice. For example, it may be technically preferable to initially deploy some technology and functionality within the messaging server system 406 but to later migrate this technology and functionality to the messaging client 402 where a client device 328 has sufficient processing capacity.

The messaging server system 406 supports various services and operations that are provided to the messaging client 402. Such operations include transmitting data to, receiving data from, and processing data generated by the messaging client 402. This data may include message content, client device information, geolocation information, media augmentation and overlays, message content persistence conditions, social network information, and live event information, as examples. Data exchanges within the messaging system 400 are invoked and controlled through functions available via user interfaces (UIs) of the messaging client 402.

Turning now specifically to the messaging server system 406, an Application Program Interface (API) server 410 is coupled to, and provides a programmatic interface to, Application servers 414. The Application servers 414 are communicatively coupled to a database server 416, which facilitates access to a database 420 that stores data associated with messages processed by the Application servers 414. Similarly, a web server 424 is coupled to the Application servers 414, and provides web-based interfaces to the Application servers 414. To this end, the web server 424 processes incoming network requests over the Hypertext Transfer Protocol (HTTP) and several other related protocols.

The Application Program Interface (API) server 410 receives and transmits message data (e.g., commands and message payloads) between the client device 328 and the Application servers 414. Specifically, the Application Program Interface (API) server 410 provides a set of interfaces (e.g., routines and protocols) that can be called or queried by the messaging client 402 in order to invoke functionality of the Application servers 414. The Application Program Interface (API) server 410 exposes various functions supported by the Application servers 414, including account registration, login functionality, the sending of messages, via the Application servers 414, from a particular messaging client 402 to another messaging client 402, the sending of media files (e.g., images or video) from a messaging client 402 to a messaging server 412, and for possible access by another messaging client 402, the settings of a collection of media data (e.g., story), the retrieval of a list of friends of a user of a client device 328, the retrieval of such collections, the retrieval of messages and content, the addition and deletion of entities (e.g., friends) to an entity graph (e.g., a social graph), the location of friends within a social graph, and opening an Application event (e.g., relating to the messaging client 402).

The Application servers 414 host a number of server Applications and subsystems, including for example a messaging server 412, an image processing server 418, and a social network server 422. The messaging server 412 implements a number of message processing technologies and functions, particularly related to the aggregation and other processing of content (e.g., textual and multimedia content) included in messages received from multiple instances of the messaging client 402. As will be described in further detail, the text and media content from multiple sources may be aggregated into collections of content (e.g., called stories or galleries). These collections are then made available to the messaging client 402. Other processor and memory intensive processing of data may also be performed server-side by the messaging server 412, in view of the hardware requirements for such processing.

The Application servers 414 also include an image processing server 418 that is dedicated to performing various image processing operations, typically with respect to images or video within the payload of a message sent from or received at the messaging server 412.

The social network server 422 supports various social networking functions and services and makes these functions and services available to the messaging server 412. To this end, the social network server 422 maintains and accesses an entity graph within the database 420. Examples of functions and services supported by the social network server 422 include the identification of other users of the messaging system 400 with which a particular user has relationships or is “following,” and also the identification of other entities and interests of a particular user.

The messaging client 402 can notify a user of the client device 328, or other users related to such a user (e.g., “friends”), of activity taking place in shared or shareable sessions. For example, the messaging client 402 can provide participants in a conversation (e.g., a chat session) in the messaging client 402 with notifications relating to the current or recent use of a game by one or more members of a group of users. One or more users can be invited to join in an active session or to launch a new session. In example embodiments, shared sessions can provide a shared augmented reality experience in which multiple people can collaborate or participate.

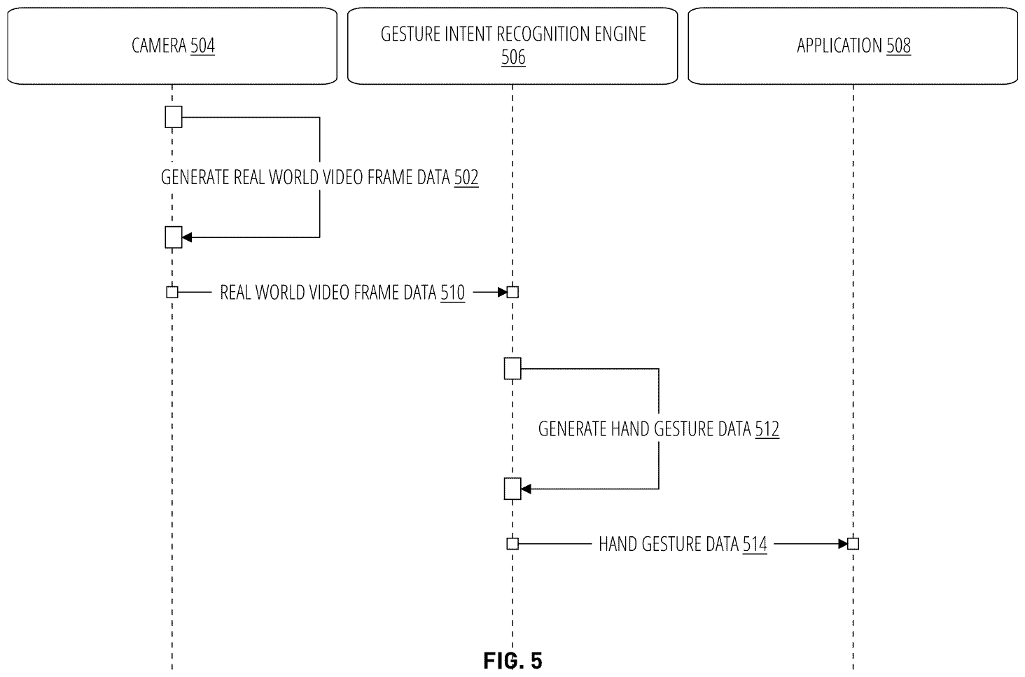

FIG. 5 depicts a sequence diagram of an example user interface process in accordance with some examples. One or more cameras 504 (e.g., cameras 114, 116, and/or additional cameras totaling four or more cameras) of the glasses 100 generate real world video frame data 502 of a real world as viewed by a user of the glasses 100. Included in the real world video frame data 510, which is communicated to the gesture intent recognition engine 506, is hand position video frame data of one or more of the user's hands from a viewpoint of the user while wearing the glasses 100 and viewing the real world through the glasses 100. Thus, the real world video frame data 510 includes hand location video frame data and hand position video frame data of the user's hands as the user makes movements with their hands. The gesture intent recognition engine 506 utilizes the hand location video frame data and hand position video frame data in the real world video frame data 510 to generate hand gesture data 512 including hand gesture categorization information indicating one or more hand gestures being made by the user. The gesture intent recognition engine 506 communicates the hand gesture data 514 to an application 508 that utilized the hand gesture data 514 as an input from a user interface.

In example embodiments, the application 508 performs the functions of the gesture intent recognition engine 506 by utilizing various APIs and system libraries to receive and process the real world video frame data 510 from the one or more cameras 504 to determine the hand gesture data 514.

In example embodiments, a user wears one or more sensor gloves on the user's hands that generate sensed hand position data and sensed hand location data that are used to generate hand gesture data 512. The sensed hand position data and sensed hand location data are communicated to the gesture intent recognition engine 506 in lieu of or in combination with the hand location video frame data and hand position video frame data to generate hand gesture data 512.

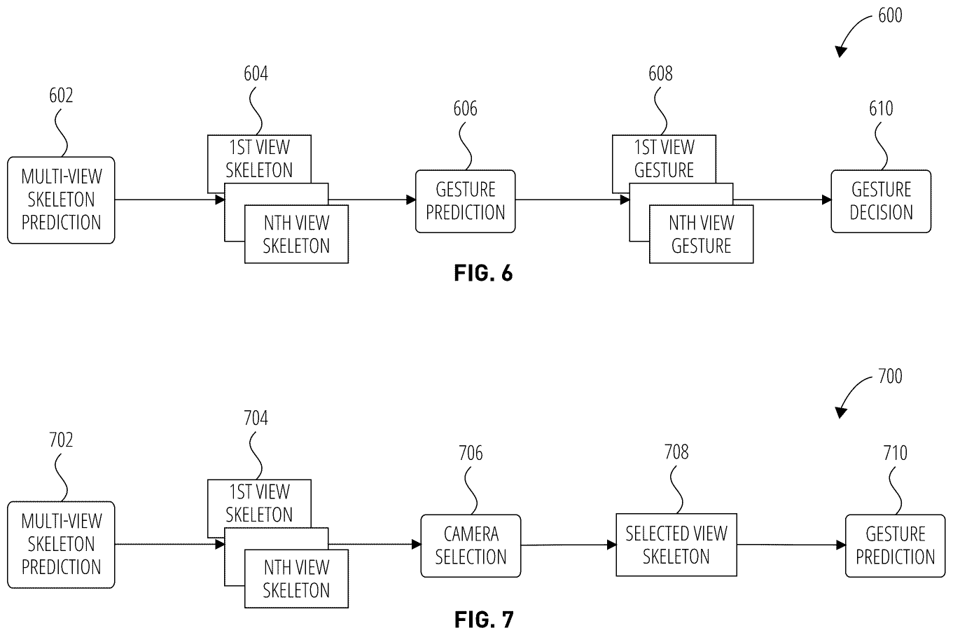

FIG. 6 illustrates a pipeline 600 for gesture recognition without camera selection, in accordance with some examples. For example, the pipeline 600 is implemented by the gesture intent recognition engine 506. For explanatory purposes, the pipeline 600 is primarily described herein with reference to the glasses 100, the client device 328 and the server system 332 (e.g., corresponding to the messaging server system 406) of FIGS. 3 and 4. However, the pipeline 600 may correspond to one or more other components and/or other suitable devices.

In the example of FIG. 6, the pipeline 600 includes a multi-view skeleton prediction module 602, predicted skeletons 604, a gesture prediction module 606, predicted gestures 608 and a gesture decision module 610. The pipeline 600 performs gesture prediction via the gesture prediction module 606 and gesture decision via the gesture decision module 610 using all device cameras (e.g., cameras 504). By using all device cameras, the pipeline 600 is accurate in gesture recognition. However, the computing resources for performing the gesture prediction and gesture decision using all of the devices cameras is relatively high, for example, relative to performing gesture prediction using a single camera as discussed further below with respect to FIG. 7.

In example embodiments, video frame data as captured by one (or more) of the cameras 504 is provided as input to the multi-view skeleton prediction module 602. For example, each of the cameras 504 is configured to capture video frame data of a real-world scene environment, from a perspective of a user of a head-worn XR device (e.g., glasses 100). The glasses 100 are configured to generate tracking video frame data based on the captured video frame data.

In example embodiments, the tracking video frame data corresponds to detectable portions of the user's body including portions of the user's upper body, arms, hands, and fingers as the user makes gestures. The tracking video frame data includes one or more of: video frame data of movement of portions of the user's upper body, arms, and hands as the user makes a gesture or moves their hands and fingers to interact with a real-world scene environment; video frame data of locations of the user's arms and hands in space as the user makes a gesture or moves their hands and fingers to interact with the real-world scene environment; and/or video frame data of positions in which the user holds their upper body, arms, hands, and fingers as the user makes a gesture or moves their hands and fingers to interact with the real-world scene environment. The tracking video frame data is provided as input to the multi-view skeleton prediction module 602.

In example embodiments, the multi-view skeleton prediction module 602 is configured to generate/predict multiple views of a skeleton based on the received tracking video frame data. Each of the multiple views corresponds to a respective view from the perspective a respective camera (e.g., one of the camera 504). As shown in the example of FIG. 6, the multi-view skeleton prediction module 602 outputs multiple views of a skeleton, namely a 1st view skeleton through an Nth view skeleton (“predicted skeletons 604”), where N corresponds to the number of cameras for the glasses 100.

In example embodiments, the multi-view skeleton prediction module 602 is configured to recognize landmark features based on the tracking video frame data. The multi-view skeleton prediction module 602 generates the multiple predicted skeletons 604 based on the recognized landmark features. For example, the landmark features include landmarks on portions of the user's hands, upper body, arms and the like in the real-world scene environment. The predicted skeletons 604 include data of a skeletal model representing portions of the user's body such as their hands and arms. In example embodiments, the predicted skeletons 604 also includes landmark data such as landmark identification, location in the real-world scene environment, segments between joints, and categorization information of one or more landmarks associated with the user's upper body, arms, and hands.

In example embodiments, the multi-view skeleton prediction module 602 recognizes landmark features based on the tracking video frame data using artificial intelligence methodologies and a multi-view skeletal prediction model previously generated using machine learning methodologies. In example embodiments, the multi-view skeletal prediction model comprises, but is not limited to, a neural network, a learning vector quantization network, a logistic regression model, a support vector machine, a random decision forest, a naïve Bayes model, a linear discriminant analysis model, and a K-nearest neighbor model. In example embodiments, machine learning methodologies may include, but are not limited to, supervised learning, unsupervised learning, semi-supervised learning, reinforcement learning, dimensionality reduction, self-learning, feature learning, sparse dictionary learning, and anomaly detection.

In example embodiments, the multi-view skeleton prediction module 602 recognizes joint features and generates low level joint gesture components representing joints of the user. These can be virtual representations of natural joint positions on the user's body, such as, but not limited to fingertips, finger joints, wrists, elbows, shoulders, and so forth. A 3D marker that can be defined on the user is included in this category, even if it does not relate to a physical joint. As shown in the example of FIG. 6, the multi-view skeletal prediction model communicates the predicted skeletons 604 to the gesture prediction module 606.

As noted above, each of the predicted skeletons 604 corresponds to the respective view from the perspective a single device camera (e.g., one of the cameras 504). Thus, the multi-view skeleton prediction module 602 is configured (e.g., using the above-described multi-view skeletal prediction model) to predict, for each camera, a respective view of the skeleton corresponding to the tracking video frame data. In this manner, it is possible for the video frame data to be captured by a single camera (e.g., one of the cameras 504), and for multiple predicted skeletons 604 to be generated/predicted from that video frame data.

As shown in the example of FIG. 6, the gesture prediction module 606 is configured to receive the predicted skeletons 604 as input, and to predict a respective gesture (e.g., a hand gesture) for each of the predicted skeletons 604. In other words, for each of the 1st view skeleton through the Nth view skeleton, the gesture prediction module 606 predicts a 1st view gesture through an Nth view gesture. In determining the predicted gestures 608, the gesture prediction module 606 is configured to recognize gesture components from the predicted skeletons 604.

For example, recognizing the gesture components includes one or more of: determining confidence values (e.g., indicating a degree of confidence of a specific gesture component); recognizing handshape gesture components (e.g., including distinct finger configurations such as bendedness, tiltness and relative position for of a user's hand); recognizing best-matched gesture components (e.g., a most likely matched gesture component or group at a given moment for the given hand); recognizing space gesture components (e.g., a specific aspect any spatial data that can be visually perceived); recognizing derived continuous gesture components (e.g., features that can be extracted at multiple timestamps and hence form a continuous stream of data); recognizing distance gesture components composed of distance features (e.g., derived from distances between two or more specified points of the user's body); recognizing symmetry gesture components (e.g., complete or partial symmetry included in hand data that is continuously defined at a sequence of timestamps); recognizing movement gesture components (e.g., based on movement markers corresponding to a continuous 3D trajectory determined for a hand that is optimized for a shape of the 3D trajectory); recognizing position gesture components (e.g., based on position markers which are optimized for a position of a user's hand); recognizing interaction gesture components (e.g., specific movement marker of the hand that targets natural points of interaction based on a handshape); recognizing rotation gesture components; recognizing delta motion gesture components (e.g., based on rotation markers which are similar to position markers, but composed of a 3D rotation of a hand at a given time); recognizing pinch gesture components (e.g., where a tightness of pinch marker is a continuous evaluation of how much a pinch or grab hand position is closed); recognizing temporal segment gesture components (e.g., based on basis of temporal segmentation of the predicted skeletons 604); recognizing aggregate gesture components (e.g., aggregating multiple gesture components across multiple temporal segment boundaries); and/or recognizing continuous movement gesture components (e.g., temporal segments with definite movement gesture components and their derivatives recognized as additional features). The gesture prediction module 606 is configured to generate gesture component data which represents or otherwise indicates the recognize gesture components.

For each of the predicted skeletons 604 (e.g., the 1st predicted skeleton through the Nth predicted skeleton), the gesture prediction module 606 is configured to predict a corresponding gesture (e.g., the 1st view gesture through the Nth view gesture), based on the gesture component data indicating the recognized gesture components. In example embodiments, the gesture prediction module 606 recognizes gestures on the basis of a comparison of gesture components identified in the gesture component data to gesture identification models identifying specific gestures. In example embodiments, the gesture prediction module 606 predicts gestures based on the gesture component data using artificial intelligence methodologies and one or more gesture models previously generated using machine learning methodologies. In example embodiments, a gesture model comprises, but is not limited to, a neural network, a learning vector quantization network, a logistic regression model, a support vector machine, a random decision forest, a naïve Bayes model, a linear discriminant analysis model, and a K-nearest neighbor model. In example embodiments, machine learning methodologies include, but are not limited to, supervised learning, unsupervised learning, semi-supervised learning, reinforcement learning, dimensionality reduction, self-learning, feature learning, sparse dictionary learning, and anomaly detection.

As shown in the example of FIG. 6, the predicted gestures 608 produced by the gesture prediction module 606 are provided as input to the gesture decision module 610. As noted above, each of the predicted gestures 608 may have a confidence value associated therewith, together with the recognized pattern components. Based on predicted gestures for predicted gestures 608, the gesture decision module 610 decides/selects a gesture for video frame data as captured by the cameras (e.g., the cameras 504).

FIG. 7 illustrates a pipeline 700 for gesture recognition with camera selection, in accordance with some examples. For example, the pipeline 700 is implemented by the gesture intent recognition engine 506. For explanatory purposes, the pipeline 700 is primarily described herein with reference to the glasses 100, the client device 328 and the server system 332 (e.g., corresponding to the messaging server system 406) of FIGS. 3 and 4. However, the pipeline 700 may correspond to one or more other components and/or other suitable devices.

In the example of FIG. 7, the pipeline 700 includes a multi-view skeleton prediction module 702, predicted skeletons 704, a camera selection module 706, a selected view skeleton 708 and a gesture prediction module 710. The pipeline 700 performs smart camera selection via the camera selection module 706 (e.g., selecting a single camera from among all device cameras for gesture recognition). Based on the single view skeleton associated with the selected camera, the pipeline 700 performs gesture prediction via the gesture prediction module 710.

The computing resources for performing the gesture recognition using a single camera is relatively low, for example, compared to performing the gesture prediction and gesture decision using all of the devices cameras as described above with respect to FIG. 6. Moreover, by performing camera selection associated with a single view skeleton, the pipeline 600 is still accurate in gesture recognition. Due to occlusion (e.g., including self-occlusion) of the hand, certain cameras may have a better angle to detect certain gestures (e.g., a pinch gesture). Thus, the pipeline 700 aims to select a single camera from which a given gesture is most visible.

In example embodiments, elements 702 to 704 of FIG. 7 are similar to elements 602 to 604 of FIG. 6. Video frame data as captured by one (or more) of the cameras 504 is provided as input to the multi-view skeleton prediction module 702. For example, each of the cameras 504 is configured to capture video frame data of a real-world scene environment, from a perspective of a user of a head-worn XR device (e.g., glasses 100). The glasses 100 are configured to generate tracking video frame data based on the captured video frame data.

In example embodiments, the tracking video frame data corresponds to detectable portions of the user's body including portions of the user's upper body, arms, hands, and fingers as the user makes gestures. The tracking video frame data includes one or more of: video frame data of movement of portions of the user's upper body, arms, and hands as the user makes a gesture or moves their hands and fingers to interact with a real-world scene environment; video frame data of locations of the user's arms and hands in space as the user makes a gesture or moves their hands and fingers to interact with the real-world scene environment; and/or video frame data of positions in which the user holds their upper body, arms, hands, and fingers as the user makes a gesture or moves their hands and fingers to interact with the real-world scene environment. Thus, the tracking video frame data is provided as input to the multi-view skeleton prediction module 702.

In example embodiments, the multi-view skeleton prediction module 702 is configured to generate/predict multiple views of a skeleton based on the received tracking video frame data. Each of the multiple views corresponds to a respective view from the perspective of one of the cameras (e.g., one of the cameras 504). As shown in the example of FIG. 7, the multi-view skeleton prediction module 702 outputs multiple views of a skeleton, namely a 1st view skeleton through an Nth view skeleton (“predicted skeletons 704”), where N corresponds to the number of cameras for the glasses 100.

In example embodiments, the multi-view skeleton prediction module 702 is configured to recognize landmark features based on the tracking video frame data. The multi-view skeleton prediction module 702 generates the multiple predicted skeletons 704 based on the recognized landmark features. For example, the landmark features include landmarks on portions of the user's hands, upper body, arms and the like in the real-world scene environment. The predicted skeletons 704 include data of a skeletal model representing portions of the user's body such as their hands and arms. In example embodiments, the predicted skeletons 704 also includes landmark data such as landmark identification, location in the real-world scene environment, segments between joints, and categorization information of one or more landmarks associated with the user's upper body, arms, and hands.

In example embodiments, the multi-view skeleton prediction module 702 recognizes landmark features based on the tracking video frame data using artificial intelligence methodologies and a multi-view skeletal prediction model previously generated using machine learning methodologies. In example embodiments, the multi-view skeletal prediction model comprises, but is not limited to, a neural network, a learning vector quantization network, a logistic regression model, a support vector machine, a random decision forest, a naïve Bayes model, a linear discriminant analysis model, and a K-nearest neighbor model. In example embodiments, machine learning methodologies may include, but are not limited to, supervised learning, unsupervised learning, semi-supervised learning, reinforcement learning, dimensionality reduction, self-learning, feature learning, sparse dictionary learning, and anomaly detection.

In example embodiments, the multi-view skeleton prediction module 702 recognizes joint features and generates low level joint gesture components representing joints of the user. These can be virtual representations of natural joint positions on the user's body, such as, but not limited to fingertips, finger joints, wrists, elbows, shoulders, and so forth. A 3D marker that can be defined on the user is included in this category, even if it does not relate to a physical joint. As shown in the example of FIG. 7, the multi-view skeletal prediction model communicates the predicted skeletons 704 to the camera selection module 706.

As noted above, each of the predicted skeletons 704 corresponds to the respective view from the perspective of a single device camera (e.g., one of the cameras 504). Thus, the multi-view skeleton prediction module 702 is configured (e.g., using the above-described multi-view skeletal prediction model) to predict, for each camera, a respective view of the skeleton corresponding to the tracking video frame data. In this manner, it is possible for the video frame data to be captured by a single camera (e.g., one of the cameras 504), and for multiple predicted skeletons 604 to be generated/predicted based on that video frame data.

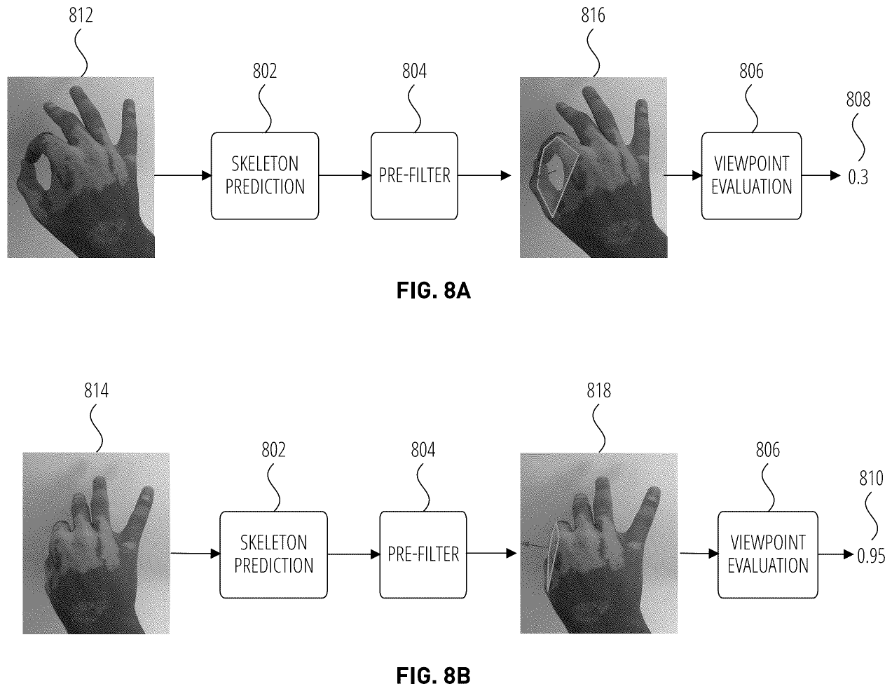

As shown in the example of FIG. 7, the camera selection module 706 is configured to receive the predicted skeletons 704 as input, and to choose a selected view skeleton 708 from among the predicted skeletons 704 as output. As discussed below with respect to FIGS. 7 and 8, the camera selection module 706 is configured to select a predicted skeleton based on either skeleton-based rules or a neural-network based prediction.

As shown in the example of FIG. 7, the camera selection module 706 communicates the selected view skeleton 708 to the gesture prediction module 710. In example embodiments, the gesture prediction module 710 is configured to receive the selected view skeleton 708 as input, and to predict a gesture (e.g., a hand gesture) for the selected view skeleton 708. In predicting the view gesture, the gesture prediction module 710 is configured to recognize gesture components from the selected view skeleton 708.

For example, recognizing the gesture components includes one or more of: determining confidence values (e.g., indicating a degree of confidence of a specific gesture component); recognizing handshape gesture components (e.g., including distinct finger configurations such as bendedness, tiltness and relative position for of a user's hand); recognizing best-matched gesture components (e.g., a most likely matched gesture component or group at a given moment for the given hand); recognizing space gesture components (e.g., a specific aspect any spatial data that can be visually perceived); recognizing derived continuous gesture components (e.g., features that can be extracted at multiple timestamps and hence form a continuous stream of data); recognizing distance gesture components composed of distance features (e.g., derived from distances between two or more specified points of the user's body); recognizing symmetry gesture components (e.g., complete or partial symmetry included in hand data that is continuously defined at a sequence of timestamps); recognizing movement gesture components (e.g., based on movement markers corresponding to a continuous 3D trajectory determined for a hand that is optimized for a shape of the 3D trajectory); recognizing position gesture components (e.g., based on position markers which are optimized for a position of a user's hand); recognizing interaction gesture components (e.g., specific movement marker of the hand that targets natural points of interaction based on a handshape); recognizing rotation gesture components; recognizing delta motion gesture components (e.g., based on rotation markers which are similar to position markers, but composed of a 3D rotation of a hand at a given time); recognizing pinch gesture components (e.g., where a tightness of pinch marker is a continuous evaluation of how much a pinch or grab hand position is closed); recognizing temporal segment gesture components (e.g., based on basis of temporal segmentation of the predicted skeletons 604); recognizing aggregate gesture components (e.g., aggregating multiple gesture components across multiple temporal segment boundaries); and/or recognizing continuous movement gesture components (e.g., temporal segments with definite movement gesture components and their derivatives recognized as additional features). The gesture prediction module 606 is configured to generate gesture component data which represents or otherwise indicates the recognize gesture components.

In example embodiments, the gesture prediction module 710 is configured to predict a gesture, based on the gesture component data indicating the recognized gesture components. In example embodiments, the gesture prediction module 710 recognizes gestures on the basis of a comparison of gesture components identified in the gesture component data to gesture identification models identifying specific gestures. In example embodiments, the gesture prediction module 710 predicts gestures based on the gesture component data using artificial intelligence methodologies and one or more gesture models previously generated using machine learning methodologies. In example embodiments, a gesture model comprises, but is not limited to, a neural network, a learning vector quantization network, a logistic regression model, a support vector machine, a random decision forest, a naïve Bayes model, a linear discriminant analysis model, and a K-nearest neighbor model. In example embodiments, machine learning methodologies include, but are not limited to, supervised learning, unsupervised learning, semi-supervised learning, reinforcement learning, dimensionality reduction, self-learning, feature learning, sparse dictionary learning, and anomaly detection.

By virtue of selecting a single camera selecting a single camera from among all device cameras, the pipeline 700 provides for reducing computer resource consumption (e.g., relative to the pipeline 600) while maintaining high accuracy for gesture recognition. Rather than performing a resource-intensive process of running gesture recognition processing with respect to each camera (e.g., image sensor), the camera selection module 706 provides for selecting a camera from which a given gesture is most visible, and running gesture recognition with respect to the selected camera.

While the pipeline 700 as described relates to gesture recognition of an XR device, it is noted that the camera selection module 706 and the selected view skeleton 708 is not limited to such. In example embodiments, the camera selection module 706 and the selected view skeleton 708 may be incorporated into a different device with multiple cameras mounted thereon for classifying an attribute of an object (e.g., the positioning of landmarks on an object). For example, a robot with cameras mounted thereon may be configured to hold and position an object (e.g., a mug with a handle, a bendable puzzle, a tool, and the like). The pipeline 700 may provide for the multi-view skeleton prediction module 702 to provide multiple predicted skeletons 704 of the object, and for the camera selection module 706 to select a camera from which a given position or orientation of a landmark of the object (e.g., a mug handle) is most visible. The selected camera may be used as a single camera to classify, identify, or otherwise analyze the object and/or its landmark(s).

FIGS. 8A-8B illustrate examples of selecting a camera based on skeleton-based rules, in accordance with some examples. The example of FIGS. 8A-8B includes a skeleton prediction module 802 (e.g., corresponding to the multi-view skeleton prediction module 702), a pre-filter module 804, a viewpoint evaluation module 806 (e.g., for calculating dot product values 808-810), images 812 and 814, and pinch planes 816-818.

As noted above with respect to FIG. 7, the camera selection module 706 is configured to select a single predicted skeleton (e.g., the selected view skeleton 708) for gesture recognition via the gesture prediction module 710. In the example of FIGS. 8A-8B, selection of the single skeleton is based on skeleton-based rules. In particular, the skeleton-based rules relate to selecting a skeleton based on a viewpoint evaluation (e.g., a skeleton with the lowest dot product with respect to pinch plane direction and camera view ray).

FIGS. 8A-8B illustrate an example in which one or more images 812-814 (e.g., video frame data) are provided to the skeleton prediction module 802 (e.g., corresponding to the multi-view skeleton prediction module 702). As noted above, the skeleton prediction module 802 is configured to generate respective predicted skeletons from the perspective of a respective camera (e.g., one of the cameras 504) of the glasses 100. The camera selection module 706 is configured to calculate a pinch plane (e.g., pinch planes 816-818) for each of the predicted skeletons.

Prior to calculating the pinch plane, the pre-filter module 804 is configured to filter out predicted skeletons based on one or more of: distance (e.g., pre-filtering based on distances between two or more specified points of the user's hand/body); position (e.g., pre-filtering based on position markers associated with a user's hand); orientation (e.g., pre-filtering based on orientation of the with a user's hand); and/or context (e.g., pre-filtering based on context associated with a user's hand or other contextual factors). Thus, in a case where the pre-filter module 804 filters out a particular predicted skeleton, the predicted skeleton is automatically disqualified for selection, without further processing (e.g., without viewpoint evaluation, such as without determining the pinch plane and associated dot product for the predicted skeleton). This may further reduce computational resources.

For the predicted skeletons that are not filtered out by the pre-filter module 804, the camera selection module 706 selects the predicted skeleton having the most visible pinch plane. In particular, the viewpoint evaluation module 806 calculates a viewpoint evaluation value (e.g., the dot product for the pinch plane and camera view ray), and the camera selection module 706 selects the predicted skeleton based on the viewpoint evaluation value (e.g., the smallest dot product which corresponds to the most visible pinch plane). As shown in the example of FIGS. 8A-8B, the pinch plane 816 is more visible than the pinch plane module 818, with the dot product value 808 (e.g., 0.3) being smaller than the dot product value 810 (e.g., 0.95). Thus, the camera selection module 706 selects the predicted skeleton corresponding to FIG. 8A as the selected view skeleton 708 for FIG. 7.

While the example of FIGS. 8A-8B describes the viewpoint evaluation module 806 with respect to determining a pinch plane and calculating a dot product value, it is noted that the viewpoint evaluation module 806 is not limited to such. As noted above, the camera selection module 706 and the selected view skeleton 708 may be incorporated into a different device with multiple cameras mounted thereon for classifying an attribute of an object (e.g., the positioning of landmarks on an object). Thus, the viewpoint evaluation module 806 may be configured to determine a different value, other than a dot product value associated with a pinch plane, for evaluating camera viewpoints.

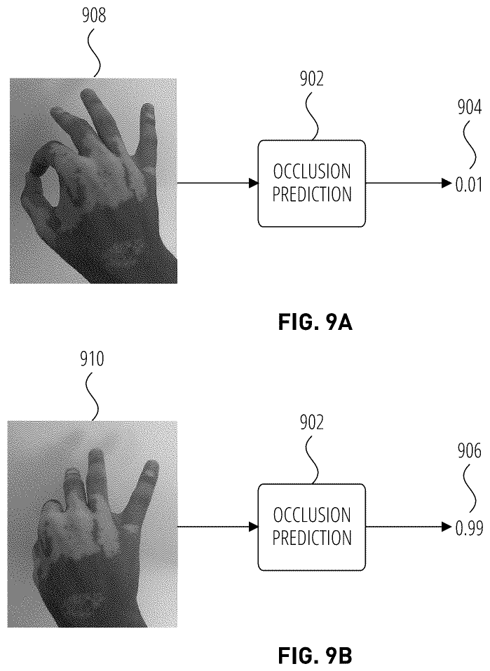

FIGS. 9A-9B illustrate examples of selecting a camera using a neural-network based prediction, in accordance with some examples. The example of FIGS. 9A-9B include an occlusion prediction module 902, which takes images 908-910 as input, and provides occlusion values 904-906 as output.

As noted above with respect to FIG. 7, the camera selection module 706 is configured to select a single predicted skeleton (e.g., the selected view skeleton 708) for gesture recognition via the gesture prediction module 710. In the example of FIGS. 9A-9B, selection of the single skeleton is based on a neural-network based prediction. In particular, the neural-network based prediction relates to selecting a predicted skeleton with a lowest occlusion value.

FIGS. 9A-9B illustrate an example in which one or more images 908-910 (e.g., corresponding to respective predicted skeletons) are provided to the occlusion prediction module 902, and. The occlusion prediction module 902 implements or otherwise accesses a neural network which is configured to predict an occlusion value (e.g., occlusion values 904-906) for each predicted skeleton.

In example embodiments, the occlusion prediction module 902 determines occlusion values from the predicted skeletons using artificial intelligence methodologies and an occlusion prediction model previously generated using machine learning methodologies. In example embodiments, the occlusion prediction model comprises, but is not limited to, a neural network, a learning vector quantization network, a logistic regression model, a support vector machine, a random decision forest, a naïve Bayes model, a linear discriminant analysis model, and a K-nearest neighbor model. In example embodiments, machine learning methodologies may include, but are not limited to, supervised learning, unsupervised learning, semi-supervised learning, reinforcement learning, dimensionality reduction, self-learning, feature learning, sparse dictionary learning, and anomaly detection.

In example embodiments, the camera selection module 706 selects the predicted skeleton with the least amount of occlusion (e.g., the smallest occlusion value). As shown in the example of FIGS. 9A-9B, the occlusion value 904 (e.g., 0.01) is smaller than occlusion value 906 (e.g., 0.99). Thus, the camera selection module 706 selects the predicted skeleton corresponding to FIG. 9A as the selected view skeleton 708 for FIG. 7.

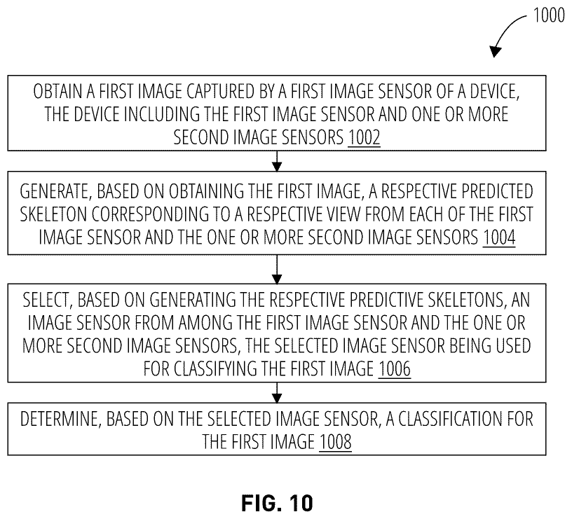

FIG. 10 is a flowchart illustrating a process 1000 for selecting an image sensor for object classification, in this case gesture recognition, in accordance with some examples. For explanatory purposes, the process 1000 is primarily described herein with reference to the glasses 100, the client device 328 and the server system 332 (e.g., corresponding to the messaging server system 406) of FIGS. 3 and 4. However, one or more blocks (or operations) of the process 1000 may be performed by one or more other components, and/or by other suitable devices. Further for explanatory purposes, the blocks (or operations) of the process 1000 are described herein as occurring in serial, or linearly. However, multiple blocks (or operations) of the process 1000 may occur in parallel or concurrently. In addition, the blocks (or operations) of the process 1000 need not be performed in the order shown and/or one or more blocks (or operations) of the process 1000 need not be performed and/or can be replaced by other operations. The process 1000 may be terminated when its operations are completed. In addition, the process 1000 may correspond to a method, a procedure, an algorithm, etc.

At block 1002, the glasses 100 in conjunction with the client device 328 and the server system 332 (or the “XR device system”) obtains a first image captured by a first image sensor (e.g., one of the cameras 504) of the glasses 100, the glasses 100 including the first image sensor and one or more second image sensors (e.g., the remaining cameras 504). In example embodiments, the first image corresponds to an object, and the classification corresponds to an identification of the object or a position of the object. For example, the object is a hand, and the classification corresponds to a hand gesture.

At block 1004, the XR device system generates, based on obtaining the first image, a respective predicted skeleton corresponding to a respective view from each of the first image sensor and the one or more second image sensors. At block 1006, the XR device system selects, based on generating the respective predicted skeletons, an image sensor from among the first image sensor and the one or more second image sensors, the selected image sensor being used for classifying the first image.

In example embodiments, selecting the image sensor includes determining a pinch plane for each of the respective predicted skeletons; calculating a dot product value for each of the pinch planes, such that each of the first image sensor and the one or more second image sensors has a dot product value associated therewith; and selecting, based on calculating the dot product value and from among the first image sensor and the one or more second image sensors, the image sensor having a lowest dot product value associated therewith.

In example embodiments, selecting the image sensor comprises: determining, using a first neural network, an occlusion value for each of the respective predicted skeletons, such that each of the first image sensor and the one or more second image sensors has an occlusion value associated therewith; and selecting, based on determining the occlusion value and from among the first image sensor and the one or more second image sensors, the image sensor having a lowest occlusion value associated therewith.

At block 1008, the XR device system determines, based on the selected image sensor, a classification for the first image. In example embodiments, generating the respective predicted skeletons uses a second neural network which is separate from the first neural network. In addition, determining the classification uses a third neural network which is separate from the first neural network and from the second neural network.

FIG. 11 is a block diagram 1100 illustrating a software architecture 1104, which can be installed on any one or more of the devices described herein. The software architecture 1104 is supported by hardware such as a machine 1102 that includes processors 1120, memory 1126, and I/O components 1138. In this example, the software architecture 1104 can be conceptualized as a stack of layers, where individual layers provides a particular functionality. The software architecture 1104 includes layers such as an operating system 1112, libraries 1108, frameworks 1110, and Applications 1106. Operationally, the Applications 1106 invoke API calls 1150 through the software stack and receive messages 1152 in response to the API calls 1150.

The operating system 1112 manages hardware resources and provides common services. The operating system 1112 includes, for example, a kernel 1114, services 1116, and drivers 1122. The kernel 1114 acts as an abstraction layer between the hardware and the other software layers. For example, the kernel 1114 provides memory management, processor management (e.g., scheduling), component management, networking, and security settings, among other functionalities. The services 1116 can provide other common services for the other software layers. The drivers 1122 are responsible for controlling or interfacing with the underlying hardware. For instance, the drivers 1122 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1108 provide a low-level common infrastructure used by the Applications 1106. The libraries 1108 can include system libraries 1118 (e.g., C standard library) that provide functions such as memory allocation functions, string manipulation functions, mathematic functions, and the like. In addition, the libraries 1108 can include API libraries 1124 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) graphic content on a display, GLMotif used to implement 3D user interfaces), image feature extraction libraries (e.g. OpenIMAJ), database libraries (e.g., SQLite to provide various relational database functions), web libraries (e.g., WebKit to provide web browsing functionality), and the like. The libraries 1108 can also include a wide variety of other libraries 1128 to provide many other APIs to the Applications 1106.

The frameworks 1110 provide a high-level common infrastructure that is used by the Applications 1106. For example, the frameworks 1110 provide various graphical user interface (GUI) functions, high-level resource management, and high-level location services. The frameworks 1110 can provide a broad spectrum of other APIs that can be used by the Applications 1106, some of which may be specific to a particular operating system or platform.

In an example, the Applications 1106 may include a home Application 1136, a contacts Application 1130, a browser Application 1132, a book reader Application 1134, a location Application 1142, a media Application 1144, a messaging Application 1146, a game Application 1148, and a broad assortment of other Applications such as third-party Applications 1140. The Applications 1106 are programs that execute functions defined in the programs. Various programming languages can be employed to create one or more of the Applications 1106, structured in a variety of manners, such as object-oriented programming languages (e.g., Objective-C, Java, or C++) or procedural programming languages (e.g., C or assembly language). In a specific example, the third-party Applications 1140 (e.g., Applications developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party Applications 1140 can invoke the API calls 1150 provided by the operating system 1112 to facilitate functionality described herein.

FIG. 12 is a diagrammatic representation of a machine 1200 within which instructions 1210 (e.g., software, a program, an Application, an applet, an app, or other executable code) for causing the machine 1200 to perform any one or more of the methodologies discussed herein may be executed. For example, the instructions 1210 may cause the machine 1200 to execute any one or more of the methods described herein. The instructions 1210 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a head-worn device (e.g., a smart watch), a smart home device (e.g., a smart appliance), other smart devices, a web appliance, a network router, a network switch, a network bridge, or any machine capable of executing the instructions 1210, sequentially or otherwise, that specify actions to be taken by the machine 1200. Further, while a single machine 1200 is illustrated, the term “machine” may also be taken to include a collection of machines that individually or jointly execute the instructions 1210 to perform any one or more of the methodologies discussed herein.

The machine 1200 may include processors 1202, memory 1204, and I/O components 1206, which may be configured to communicate with one another via a bus 1244. In an example, the processors 1202 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1208 and a processor 1212 that execute the instructions 1210. The term “processor” is intended to include multi-core processors that may comprise two or more independent processors (sometimes referred to as “cores”) that may execute instructions contemporaneously. Although FIG. 12 shows multiple processors 1202, the machine 1200 may include a single processor with a single core, a single processor with multiple cores (e.g., a multi-core processor), multiple processors with a single core, multiple processors with multiples cores, or any combination thereof.

The memory 1204 includes a main memory 1214, a static memory 1216, and a storage unit 1218, both accessible to the processors 1202 via the bus 1244. The main memory 1204, the static memory 1216, and storage unit 1218 store the instructions 1210 embodying any one or more of the methodologies or functions described herein. The instructions 1210 may also reside, completely or partially, within the main memory 1214, within the static memory 1216, within machine-readable medium 1220 within the storage unit 1218, within one or more of the processors 1202 (e.g., within the processor's cache memory), or any suitable combination thereof, during execution thereof by the networked system 300.

The I/O components 1206 may include a wide variety of components to receive input, provide output, produce output, transmit information, exchange information, capture measurements, and so on. The specific I/O components 1206 that are included in a particular machine will depend on the type of machine. For example, portable machines such as mobile phones may include a touch input device or other such input mechanisms, while a headless server machine will likely not include such a touch input device. It will be appreciated that the I/O components 1206 may include many other components that are not shown in FIG. 12. In various examples, the I/O components 1206 may include output components 1228 and input components 1232. The output components 1228 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1232 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 1206 may include biometric components 1234, motion components 1236, environmental components 1238, or position components 1240, among a wide array of other components. For example, the biometric components 1234 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1236 include acceleration sensor components (e.g., accelerometer), gravitation sensor components, rotation sensor components (e.g., gyroscope), and so forth. The environmental components 1238 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1240 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1206 further include communication components 1242 operable to couple the networked system 300 to a network 1222 or devices 1224 via a coupling 1230 and a coupling 1226, respectively. For example, the communication components 1242 may include a network interface component or another suitable device to interface with the network 1222. In further examples, the communication components 1242 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1224 may be another machine or any of a wide variety of peripheral devices (e.g., a peripheral device coupled via a USB).

Moreover, the communication components 1242 may detect identifiers or include components operable to detect identifiers. For example, the communication components 1242 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1242, such as location via Internet Protocol (IP) geolocation, location via Wi-Fi® signal triangulation, location via detecting an NFC beacon signal that may indicate a particular location, and so forth.

The various memories (e.g., memory 1204, main memory 1214, static memory 1216, and/or memory of the processors 1202) and/or storage unit 1218 may store one or more sets of instructions and data structures (e.g., software) embodying or used by any one or more of the methodologies or functions described herein. These instructions (e.g., the instructions 1210), when executed by processors 1202, cause various operations to implement the disclosed examples.

The instructions 1210 may be transmitted or received over the network 1222, using a transmission medium, via a network interface device (e.g., a network interface component included in the communication components 1242) and using any one of a number of well-known transfer protocols (e.g., hypertext transfer protocol (HTTP)). Similarly, the instructions 1210 may be transmitted or received using a transmission medium via the coupling 1226 (e.g., a peer-to-peer coupling) to the devices 1224.

A “carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

A “client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

A “communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

A “component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing some operations and may be configured or arranged in a particular physical manner. In various examples, one or more computer systems (e.g., a standalone computer system, a client computer system, or a server computer system) or one or more hardware components of a computer system (e.g., a processor or a group of processors) may be configured by software (e.g., an Application or Application portion) as a hardware component that operates to perform some operations as described herein. A hardware component may also be implemented mechanically, electronically, or any suitable combination thereof. For example, a hardware component may include dedicated circuitry or logic that is permanently configured to perform some operations. A hardware component may be a special-purpose processor, such as a field-programmable gate array (FPGA) or an Application specific integrated circuit (ASIC). A hardware component may also include programmable logic or circuitry that is temporarily configured by software to perform some operations. For example, a hardware component may include software executed by a general-purpose processor or other programmable processor. Once configured by such software, hardware components become specific machines (or specific components of a machine) tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) is to be understood to encompass a tangible entity, be that an entity that is physically constructed, permanently configured (e.g., hardwired), or temporarily configured (e.g., programmed) to operate in a particular manner or to perform some operations described herein. Considering examples in which hardware components are temporarily configured (e.g., programmed), the hardware components may not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be partially processor-implemented, with a particular processor or processors being an example of hardware. For example, some of the operations of a method may be performed by one or more processors or processor-implemented components. Moreover, the one or more processors may also operate to support performance of the relevant operations in a “cloud computing” environment or as a “software as a service” (SaaS). For example, at some of the operations may be performed by a group of computers (as examples of machines including processors), with these operations being accessible via a network (e.g., the Internet) and via one or more appropriate interfaces (e.g., an API). The performance of some of the operations may be distributed among the processors, residing within a single machine as well as being deployed across a number of machines. In example embodiments, the processors or processor-implemented components may be located in a single geographic location (e.g., within a home environment, an office environment, or a server farm). In other examples, the processors or processor-implemented components may be distributed across a number of geographic locations.

A “computer-readable medium” refers to both machine-storage media and transmission media. Thus, the terms include both storage devices/media and carrier waves/modulated data signals. The terms “machine-readable medium,” “computer-readable medium” and “device-readable medium”mean the same thing and may be used interchangeably in this disclosure.

A “machine-storage medium” refers to a single or multiple storage devices and/or media (e.g., a centralized or distributed database, and/or associated caches and servers) that store executable instructions, routines and/or data. The term includes, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at some of which are covered under the term “signal medium.”

A “processor” refers to any circuit or virtual circuit (a physical circuit emulated by logic executing on an actual processor) that manipulates data values according to control signals (e.g., “commands”, “op codes”, “machine code”, and so forth) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

A “signal medium” refers to any intangible medium that is capable of storing, encoding, or carrying the instructions for execution by a machine and includes digital or analog communications signals or other intangible media to facilitate communication of software or data. The term “signal medium” may be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

Changes and modifications may be made to the disclosed examples without departing from the scope of the present disclosure. These and other changes or modifications are intended to be included within the scope of the present disclosure, as expressed in the following claims.

What is claimed is:

1. A computer-implemented method comprising:
obtaining a first image captured by a first image sensor of a device, the device including the first image sensor and one or more second image sensors;
generating, based on obtaining the first image, a respective predicted skeleton corresponding to a respective view from each of the first image sensor and the one or more second image sensors;
selecting, based on generating the respective predicted skeletons, an image sensor from among the first image sensor and the one or more second image sensors, the selected image sensor being used for classifying the first image; and
determining, based on the selected image sensor, a classification for the first image.

2. The computer-implemented method of claim 1, wherein the first image corresponds to an object, and
wherein the classification corresponds to an identification of the object or a position of the object.

3. The computer-implemented method of claim 2, wherein the object is a hand, and
wherein the classification corresponds to a hand gesture.

4. The computer-implemented method of claim 1, wherein selecting the image sensor comprises:
determining a pinch plane for each of the respective predicted skeletons;
calculating a dot product value for each of the pinch planes, such that each of the first image sensor and the one or more second image sensors has a dot product value associated therewith; and
selecting, based on calculating the dot product value and from among the first image sensor and the one or more second image sensors, the image sensor having a lowest dot product value associated therewith.

5. The computer-implemented method of claim 1, wherein selecting the image sensor comprises:
determining, using a first neural network, an occlusion value for each of the respective predicted skeletons, such that each of the first image sensor and the one or more second image sensors has an occlusion value associated therewith; and
selecting, based on determining the occlusion value and from among the first image sensor and the one or more second image sensors, the image sensor having a lowest occlusion value associated therewith.

6. The computer-implemented method of claim 5, wherein generating the respective predicted skeletons uses a second neural network which is separate from the first neural network.

7. The computer-implemented method of claim 6, wherein determining the classification uses a third neural network which is separate from the first neural network and from the second neural network.

8. The computer-implemented method of claim 1, further comprising:
obtaining a second image captured by the selected image sensor,
wherein determining the classification for the first image is based on the second image.

9. A system comprising:
at least one processor;
at least one memory component storing instructions that, when executed by the at least one processor, cause the at least one processor to perform operations comprising:
obtaining a first image captured by a first image sensor of a device, the device including the first image sensor and one or more second image sensors;
generating, based on obtaining the first image, a respective predicted skeleton corresponding to a respective view from each of the first image sensor and the one or more second image sensors;
selecting, based on generating the respective predicted skeletons, an image sensor from among the first image sensor and the one or more second image sensors, the selected image sensor being used for classifying the first image; and
determining, based on the selected image sensor, a classification for the first image.

10. The system of claim 9, wherein the first image corresponds to an object, and
wherein the classification corresponds to an identification of the object or a position of the object.

11. The system of claim 10, wherein the object is a hand, and
wherein the classification corresponds to a hand gesture.

12. The system of claim 9, wherein selecting the image sensor comprises:
determining a pinch plane for each of the respective predicted skeletons;
calculating a dot product value for each of the pinch planes, such that each of the first image sensor and the one or more second image sensors has a dot product value associated therewith; and
selecting, based on calculating the dot product value and from among the first image sensor and the one or more second image sensors, the image sensor having a lowest dot product value associated therewith.

13. The system of claim 9, wherein selecting the image sensor comprises:
determining, using a first neural network, an occlusion value for each of the respective predicted skeletons, such that each of the first image sensor and the one or more second image sensors has an occlusion value associated therewith; and
selecting, based on determining the occlusion value and from among the first image sensor and the one or more second image sensors, the image sensor having a lowest occlusion value associated therewith.

14. The system of claim 13, wherein generating the respective predicted skeletons uses a second neural network which is separate from the first neural network.

15. The system of claim 14, wherein determining the classification uses a third neural network which is separate from the first neural network and from the second neural network.

16. The system of claim 9, the operations further comprising:
obtaining a second image captured by the selected image sensor,
wherein determining the classification for the first image is based on the second image.

17. A non-transitory computer-readable storage medium storing instructions that, when executed by at least one processor, cause the at least one processor to perform operations comprising:
obtaining a first image captured by a first image sensor of a device, the device including the first image sensor and one or more second image sensors;
generating, based on obtaining the first image, a respective predicted skeleton corresponding to a respective view from each of the first image sensor and the one or more second image sensors;
selecting, based on generating the respective predicted skeletons, an image sensor from among the first image sensor and the one or more second image sensors, the selected image sensor being used for classifying the first image; and
determining, based on the selected image sensor, a classification for the first image.

18. The non-transitory computer-readable storage medium of claim 17, wherein the first image corresponds to an object, and
wherein the classification corresponds to an identification of the object or a position of the object.

19. The non-transitory computer-readable storage medium of claim 18, wherein the object is a hand, and
wherein the classification corresponds to a hand gesture.

20. The non-transitory computer-readable storage medium of claim 17, wherein selecting the image sensor comprises:
determining a pinch plane for each of the respective predicted skeletons;
calculating a dot product value for each of the pinch planes, such that each of the first image sensor and the one or more second image sensors has a dot product value associated therewith; and
selecting, based on calculating the dot product value and from among the first image sensor and the one or more second image sensors, the image sensor having a lowest dot product value associated therewith.
